(19) United States
(12) Patent Application Publication
(10) Pub. No.: US 2009/0060611 A1
(43) Pub. Date: Mar. 5, 2009

(54) IMAGE FORMING APPARATUS

(76) Inventor: Ryuichi MINBU, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/193,262

(22) Filed: Aug. 18, 2008

(30) Foreign Application Priority Data
Aug. 31, 2007 (JP) 2007-226047

(51) Int. Cl. G03G 15/00

(52) U.S. Cl. 399/397

(57) ABSTRACT

A contact member makes contact with a surface of an image carrier belt to form a transfer nip. A guiding member guides a recording medium fed by a feeding unit to a guide target point on an upstream side of an entering point of the transfer nip on the surface of the image carrier belt in a moving direction of the image carrier belt. The guiding member is arranged at a position satisfying 100 [μm]>|L−Vt×L/Vp|, where L is distance from the entering point to the guide target point on the image carrier belt, Vp is moving speed of the recording medium, and Vt is surface moving speed of the image carrier belt

### CROSS-REFERENCE TO RELATED APPLICATIONS

The present application claims priority to and incorporates by reference the entire contents of Japanese priority document 2007-226047 filed in Japan on Aug. 31, 2007.

### BACKGROUND OF THE INVENTION

1. Field of the Invention

The present invention relates to an image forming apparatus that transfers a toner image on an image carrier belt onto a recording sheet that is held in a transfer nip formed by an endless image carrier belt and a contact member that makes contact with a surface of the image carrier belt.

2. Description of the Related Art

For example, Japanese Patent Application Laid-open No. 2004-20850 discloses an image forming apparatus that has the following configuration. An endless image carrier belt and a contact member such as a transfer roller that is brought into contact with a surface of the image carrier belt are opposed to each other via a small gap near an entrance to a transfer nip formed between the image carrier belt and the contact member in the image forming apparatus. When toner on the image carrier belt flies to the contact member at the gap due to a transfer electric field, transfer dust is generated. Therefore, typically, toner is prevented from flying from the surface of the image carrier belt at the gap by guiding a recording sheet to come into contact with the image carrier belt by a guide plate before the image carrier belt enters the transfer nip.

However, it is easy to cause image disorder in which the whole image is slightly in friction under this configuration. The image disorder apparently appears in particular when a thick sheet is used as a recording sheet. Therefore, the inventor devotedly makes researches about its cause, which leads to the following conclusion. A recording sheet is brought into contact with an image carrier belt only by a weak force by which it is possible to attach to or detach from the image carrier belt near an entrance to the transfer nip. Therefore, toner held between the belt and the recording sheet can freely move. Under this state, when a difference of speed between the image carrier belt and the recording sheet is caused, a toner image is in friction between both of them, thereby leading to image disorder.

When the image carrier belt and the recording sheet are moved at the same speed at an area at which both of them are in contact with each other near the entrance to the transfer nip, it is possible to prevent friction on the toner image. However, a speed difference is forced to appear based on the following reason. A force by which a recording sheet is pressed from an image-carrier-belt side to a contact-member side acts on at the transfer nip due to a transfer electric field or electrostatic movement of toner. For this reason, conveyance of the recording sheet near the entrance to the transfer nip is controlled by a rotation driving force of the contact member. The recording sheet is moved at a similar speed to that of a surface of the contact member. Therefore, it is suitable that a line speed of the contact member is set to be the same as a moving speed of the image carrier belt. However, a small speed difference appears by any means due to a difference in a line speed caused by a size difference for each product of a contact member. Therefore, it is difficult to avoid friction on a toner image near the entrance to the transfer nip.

### SUMMARY OF THE INVENTION

It is an object of the present invention to at least partially solve the problems in the conventional technology.

According to an aspect of the present invention, there is provided an image forming apparatus including an image carrier belt that is endlessly moved, on which a toner image is formed; a contact member that makes contact with a surface of the image carrier belt to form a transfer nip with the image carrier belt; a feeding unit that feeds a recording medium to the transfer nip; a guiding member that guides the recording medium fed by the feeding unit to a guide target point on an upstream side of an entering point at which the recording medium starts entering the transfer nip on the surface of the image carrier belt in a moving direction of the image carrier belt, which is arranged at a position satisfying 100 [μm]>|L−Vt×L/Vp|, where L is distance from the entering point to the guide target point on the image carrier belt, Vp is moving speed of the recording medium, and Vt is surface moving speed of the image carrier belt; a pressing unit that presses the image carrier belt from inside a loop such that the image carrier belt is partially wound around the contact member to extend the transfer nip to the upstream side of the surface moving direction of the image carrier belt. The guiding member includes a first guiding unit that guides the recording medium that comes into contact with a tip of the first guiding unit to the guide target point, and a second guiding unit that is made of a flexible member that guides the recording medium to the guide target point while being supported by the tip of the first guiding unit in a cantilever manner, and that is constituted to make a detach timing at which a trailing edge of the recording sheet fed to the transfer nip is detached from the second guiding unit different at a first edge part and a second edge part in a direction perpendicular to a conveying direction of the trailing edge.

Furthermore, according to another aspect of the present invention, there is provided an image forming apparatus including an image carrier belt that is endlessly moved, on which a toner image is formed; a contact member that makes contact with a surface of the image carrier belt to form a transfer nip with the image carrier belt; a feeding unit that feeds a recording medium to the transfer nip; and a guiding member that guides the recording medium fed by the feeding unit to a guide target point on an upstream side of an entering point at which the recording medium starts entering the transfer nip on the surface of the image carrier belt in a moving direction of the image carrier belt. The guiding member is arranged at a position satisfying 100 [μm]>|L−Vt×L/Vp|, where L is distance from the entering point to the guide target point on the image carrier belt, Vp is moving speed of the recording medium, and Vt is surface moving speed of the image carrier belt

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a copier according to an embodiment of the present invention;

FIG. 2 is an enlarged schematic diagram for explaining part of an inner configuration of a printer unit of the copier shown in FIG. 1;

FIG. 3 is an enlarged schematic diagram for explaining Y and C process units with an intermediate transfer belt in the copier shown in FIG. 2;

FIG. 4 is an enlarged schematic diagram for explaining a secondary transfer nip and its neighborhood;

FIG. 5 is a graph for explaining a relation between each rank of transfer deflection and a distance L;

FIG. 6 is an enlarged schematic diagram for explaining a guide plate and its neighborhood; and

FIG. 7 is a plan view of the guide plate and its neighborhood indicated in a direction of an arrow A shown in FIG. 6.

### DETAILED DESCRIPTION OF THE PREFERRED EMBODIMENTS

Exemplary embodiments of the present invention are explained in detail below with reference to the accompanying drawings.

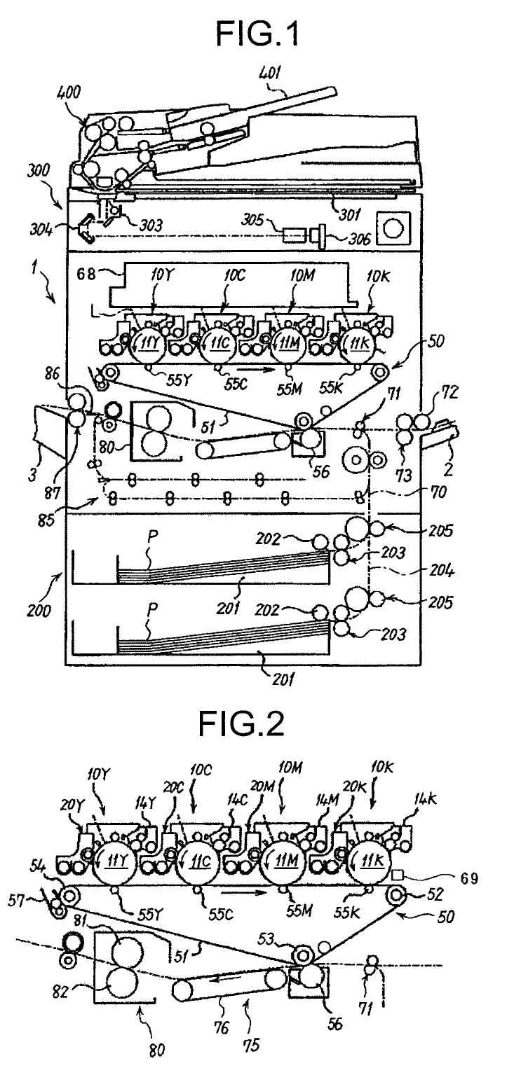

FIG. 1 is a schematic diagram of an electrophotographic copier according to an embodiment of the present invention. The copier includes a printer unit 1 by which an image is formed on a recording sheet, a feeding unit 200 that supplies recording sheets P to the printer unit 1, a scanner 300 by which an original image is read, and an automatic document feeder (ADF) 400 that automatically supplies an original to the scanner 300.

While a first scanning unit 303 including a light source that irradiates an original and a mirror and a second scanning unit 304 including a plurality of reflecting mirrors reciprocate, an original (not shown) placed on a contact glass 301 is read while scanned in the scanner 300. After a scanning light sent from the second scanning unit 304 is focused through an imaging lens 305 on an imaging surface of a reading sensor 306 arranged behind the imaging lens 305, the scanning light is read by the reading sensor 306 as an image signal.

A manual feed tray 2 and a discharging tray 3 are mounted on sides of a housing of the printer unit 1, respectively. Recording sheets P supplied inside the housing are manually placed on the manual feed tray 2. Recording sheets P on each of which an image has been formed and that are discharged from the housing are stacked on the discharging tray 3.

FIG. 2 is an enlarged schematic diagram for explaining part of an inner configuration of the printer unit 1. A transfer unit 50 in which an endless intermediate transfer belt 51 serving as an image carrier belt is stretched over a plurality of stretching rollers is arranged in the housing. While the intermediate transfer belt 51 is stretched over a driving roller 52, a secondary-transfer backup roller 53, a driven roller 54, and four primary transfer rollers 55Y, 55C, 55M, and 55K that are rotatably driven by a driving unit (not shown) clockwise in FIG. 2, the intermediate transfer belt 51 is endlessly moved clockwise based on rotation of the driving roller 52. Additional characters Y, C, M, and K added behind each of reference numerals of the primary transfer rollers mean yellow, cyan, magenta, and black. The following additional characters Y, C, M, and K behind reference numerals have the same meaning.

The intermediate transfer belt 51 is largely curved at each position of the driving roller 52, the secondary-transfer backup roller 53, and the driven roller 54 over which the intermediate transfer belt 51 is stretched. Thus, the intermediate transfer belt 51 is stretched in an upside-down triangle shape with a base of a triangle directed upward in a perpendicular direction. A surface of an upper portion of the intermediate transfer belt that corresponds to the base of the upside-down triangle is extended in parallel. Four process units 10Y, 10C, 10M, and 10K are arranged in parallel and along the surface of the upper portion of the upside-down triangle in a direction in which the surface of an upper portion of the belt is extended.

As shown in FIG. 1, an optical writing unit 68 is arranged above the process units 10Y, 10C, 10M, and 10K. Four semiconductor lasers (not shown) are driven by a laser controlling unit (not shown) in the optical writing unit 68 and emit four writing lights L based on image information of an original that is read by the scanner 300. Then, drum-type photosensitive elements 11Y, 11C, 11M, and 11K as an image carrier in the process units 10Y, 10C, 10M, and 10K are scanned in the dark by the four writing lights L, respectively. An electrostatic latent image for Y, C, M, and K is written on each of surfaces of the photosensitive elements 11Y, 11C, 11M, and 11K.

The optical writing unit 68 is used to perform optical scanning by reflecting a laser beam emitted from the semiconductor laser on a reflecting mirror (not shown) or passing the laser beam through an optical lens while the laser beam is deflected by a polygon mirror (not shown). Optical scanning can be also performed by an LED array instead of such a configuration.

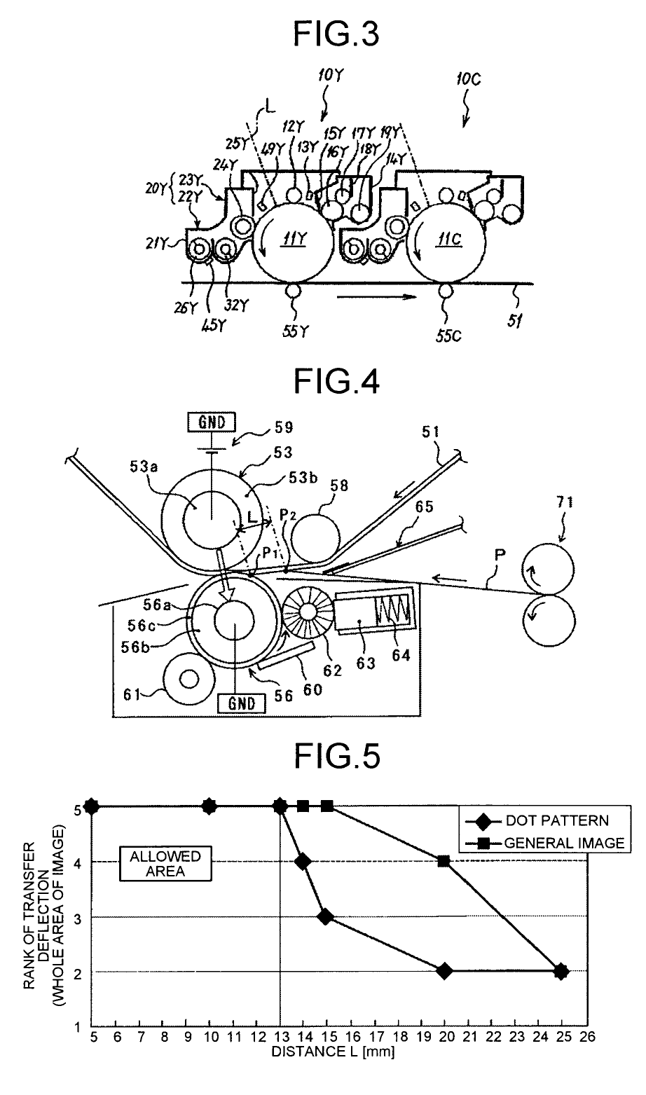

FIG. 3 is an enlarged schematic diagram for explaining the process units 10Y and 10C with the intermediate transfer belt 51. The process unit 10Y includes a charging unit 12Y, a neutralizing unit 13Y, a drum cleaning unit 14Y, a developing unit 20Y serving as a developing unit, and a potential sensor 49Y that are arranged around the photosensitive element 11Y. They are held in common by a casing as a holding unit, serve as one unit, and can be integrally attached to and detached from the printer unit 1.

The charging unit 12Y is a roller that is rotatably supported by a bearing (not shown) while coming into contact with the photosensitive element 11Y. The charging unit 12Y rotates in contact with the photosensitive element 11Y to which a charging bias is applied by a bias supplying unit (not shown), so that a surface of the photosensitive element 11Y is uniformly charged to the same polarity as that of Y toner. Instead of the charging unit 12Y that has such a configuration, it is possible to use a scorotron charger that is in noncontact with the photosensitive element 11Y and by which the photosensitive element 11Y is uniformly charged.

The developing unit 20Y in which Y developer that has magnetic carrier and nonmagnetic Y toner is contained in a casing 21Y includes a developer conveying unit 22Y and a developing unit 23Y. In the developing unit 23Y, a surface of a developing sleeve 24Y as a developer carrier is endlessly moved by being driven to rotate by a driving unit (not shown). Part of a peripheral surface of the developing sleeve 24Y is exposed outside through an opening arranged in the casing 21Y. Consequently, a developing area is formed between the photosensitive element 11Y and the developing sleeve 24Y that are opposed to each other through a predetermined space.

A magnetic roller (not shown) that includes a plurality of magnetic poles arranged in its peripheral direction is fixed inside the developing sleeve 24Y made of a nonmagnetic hollow pipe member not to move along with a movement of the developing sleeve 24Y. The developing sleeve 24Y dips out Y developer from inside the developer conveying unit 22Y in such a manner that the developing sleeve 24Y is driven to rotate while the Y developer inside the developer conveying unit 22Y is absorbed onto the surface of the developing sleeve 24Y based on a magnetic force of the magnetic roller. Then, the Y developer conveyed to the developing area based on the rotation of the developing sleeve 24Y enters into a doctor gap formed between a doctor blade 25Y and a surface of the sleeve. A tip of the doctor blade 25Y faces to the surface of the developing sleeve 24Y through a predetermined space. At this time, a thickness of a layer on the sleeve is controlled to be the same as that of the doctor gap. Then, when the Y developer is conveyed near the developing area opposed to the photosensitive element 11Y based on the rotation of the developing sleeve 24Y, a chain formation occurs on the sleeve based on a magnetic force of a developing pole (not shown) of the magnetic roller, so that a magnetic brush is formed thereon.

A developing bias that has, for example, the same polarity as the charging polarity of the toner is applied to the developing sleeve 24Y by the bias supplying unit. Therefore, in the developing area, a non-developing potential, which causes the Y toner to electrostatically move from the non-image area side to the sleeve side, acts on between the surface of the developing sleeve 24Y and a non-image area (a uniformly-charged area, i.e. a background area) of the photosensitive element 11Y. A developing potential, which causes the Y toner to electrostatically move from the sleeve side to an electrostatic latent image, acts on between the surface of the developing sleeve 24Y and the electrostatic latent image formed on the photosensitive element 11Y. The Y toner included in the Y developer is transferred to the electrostatic latent image by the action of the developing potential, so that the electrostatic latent image on the photosensitive element 11Y is developed into a Y-toner image.

The Y developer passed through the developing area based on the rotation of the developing sleeve 24Y is affected by a repulsive magnetic field formed between the repulsive magnetic poles that the magnetic roller includes, and then moves back from the developing sleeve 24Y inside the developer conveying device 22Y.

The developer conveying device 22Y includes two first screw members 26Y, a second screw member 32Y, a partition wall provided between the first and second screw members, and a toner density sensor 45Y including a permeability sensor. A first conveyance chamber in which the first screw member 26Y is contained and a second conveyance chamber in which the second screw member 32Y is contained, which are served as a developer conveying unit, are partitioned by the partition wall. However, in an area corresponding to both edges of the screw members in an axial direction, the first and second conveyance chambers are communicated with each other via an opening (not shown).

Each of the first and second screw members 26Y and 32Y as an agitation conveying member includes a stick-shaped rotating shaft member both edges of which are rotatably supported by a bearing (not shown) and a spiral blade provided in a spirally-protruding manner on a peripheral surface of the rotating shaft member. The Y developer is conveyed in a rotation-shaft direction by the spiral blade that is driven to rotate by a driving unit (not shown).

In the first conveyance chamber where the first screw member 26Y is contained, the Y developer is conveyed from the front side to the back side in a vertical direction with respect to a sheet of the drawing while the first screw member 26Y is driven to rotate. Then, when the Y developer is conveyed near an edge of the casing 21Y in the back, the Y developer enters the second conveyance chamber via the opening provided on the partition wall.

Above the second conveyance chamber in which the second screw member 32Y is contained, the developing unit 23Y is formed. The second conveyance chamber and the developing unit 23Y are communicated with each other in the whole area where the second conveyance chamber and the developing unit 23Y are faced to each other. Thus, the second screw member 32Y and the developing sleeve 24Y arranged obliquely-upward from the second screw member 32Y are opposed to each other in a parallel manner. In the second conveyance chamber, the Y developer is conveyed from the back side to the front side in the vertical direction with respect to the sheet of the drawing while the second screw member 32Y is driven to rotate. During the conveyance, the Y developer around the second screw member 32Y in its rotating direction is dipped out by the developing sleeve 24Y arbitrarily, or the Y developer after completion of the development is collected from the developing sleeve 24Y arbitrarily. Then, the Y developer conveyed near an edge of the second conveyance chamber in the front side of the drawing returns to the first conveyance chamber via the opening provided on the partition wall.

The toner density sensor 45Y as a toner-density detecting unit that includes the permeability sensor is fixed on a bottom wall of the first conveyance chamber. A toner density of the Y developer conveyed by the first screw member 26Y is detected from below by the toner density sensor 45Y, and a voltage corresponding to the result of the detection is output. Based on the output voltage from the toner density sensor 45Y, a control unit (not shown) drives a Y-toner refilling device (not shown) as needed to refill an appropriate amount of Y toner inside the first conveyance chamber. Consequently, the toner density of the Y developer, which is reduced due to the development, is recovered.

The Y-toner image formed on the photosensitive element 11Y is primarily transferred to the intermediate transfer belt 51 at a later-described primary transfer nip for Y color. Transfer remaining toner that is not primarily transferred to the intermediate transfer belt 51 is adhered to the surface of the photosensitive element 11Y after the primary transfer process of the Y-toner image.

A cleaning blade 15Y, which is made of, for example, polyurethane rubber, is supported by the drum cleaning unit 14Y in a cantilever manner. A free end of the cleaning blade 15Y is brought into contact with the surface of the photosensitive element 11Y. A tip of a brush roller 16Y is also brought into contact with the photosensitive element 11Y. The brush roller 16Y includes a rotating shaft member that is driven to rotate by a driving unit (not shown) and a large number of conductive bristles that are arranged on a peripheral surface of the rotating shaft member in a standing manner. The transfer remaining toner is scraped away from the surface of the photosensitive element 11Y by the cleaning blade 15Y and the brush roller 16Y. A cleaning bias is applied to the brush roller 16Y via a metallic electric-field roller 17Y that comes into contact with the brush roller 16Y. A tip of a scraper 18Y is brought into pressure-contact with the electric-field roller 17Y. After the transfer remaining toner scraped from the photosensitive element 11Y by the cleaning blade 15Y and the brush roller 16Y is passed through the brush roller 16Y and the electric-field roller 17Y, the transfer remaining toner is furthermore scraped from the electric-field roller 17Y by the scraper 18Y and is dropped on a collecting screw 19Y. Then, the transfer remaining toner is discharged outside the casing based on rotational driving of the collecting screw 19Y and is returned inside the developer conveying device 22Y via a toner-recycle conveying unit (not shown).

The surface of the photosensitive element 11Y on which the transfer remaining toner is cleaned by the drum cleaning unit 14Y is neutralized by the neutralizing unit 13Y including a neutralizing lamp and is uniformly charged again by the charging unit 12Y.

A potential of a non-image area of the photosensitive element 11Y after a writing light L passes through an optical writing position is detected by the potential sensor 49Y, and the result of the detection is output to the control unit.

The process unit 1OY is explained in detail above. The other process units 1OC, 1OM, and 1OK have the same configuration as that of the process unit 1OY except for a toner color to be used.

As shown in FIG. 2, each of the photosensitive elements 11Y, 11C, 11M, and 11K of the process units 1OY, 1OC, 1OM, and 1OK is rotated while in contact with the stretched upper surface of the intermediate transfer belt 51 that is endlessly moved clockwise, thereby forming a primary transfer nip for Y, C, M, or K color. In the backside of the primary transfer nips for Y, C, M, and K colors, the primary transfer rollers 55Y, 55C, 55M, and 55K are brought into contact with a rear surface of the intermediate transfer belt 51. A primary transfer bias that has a polarity opposite to the charging polarity of the toner is applied to each of the primary transfer rollers 55Y, 55C, 55M, and 55K by the bias supplying unit. A primary transfer electric-field that causes the toner to electrostatically move from the photosensitive element to the belt is formed on each of the primary transfer nips for Y, C, M, and K colors by applying the primary transfer bias. When toner images for Y, C, M, and K colors that are formed on the photosensitive elements 11Y, 11C, 11M, and 11K respectively enter the primary transfer nips for Y, C, M, and K colors based on rotation of the photosensitive elements 11Y, 11C, 11M, and 11K, the toner images are sequentially superimposed and primarily transferred to the intermediate transfer belt 51 by the actions of the primary transfer electric-field and the nip pressure. Consequently, a four-color superimposed toner image (hereinafter, a four-color toner image) is formed on the front surface (a loop outer peripheral surface) of the intermediate transfer belt 51. Alternatively, a conductive brush to which a primary transfer bias is applied or a non-contact corona charger can be employed instead of the primary transfer rollers 55Y, 55C, 55M, and 55K.

In the right of the process unit 1OK shown in FIG. 2, an optical sensor unit 69 is arranged opposite to the front surface of the intermediate transfer belt 51 through a predetermined space. The optical sensor unit 69 detects marks (not shown) dotted at an edge in a width direction of the intermediate transfer belt 51 and arranged at a predetermined pitch in a peripheral direction of the intermediate transfer belt 51. It is possible to measure a moving speed of the intermediate transfer belt 51 based on time intervals among the detected marks.

A secondary transfer roller 56 is arranged as a contact member below the intermediate transfer belt 51. The secondary transfer roller 56 is driven to rotate by a driving unit (not shown) counterclockwise and comes into contact with the front surface of the intermediate transfer belt 51 to form a secondary transfer nip. The secondary-transfer backup roller 53 is arranged on a backside of the secondary transfer nip through the intermediate transfer belt 51.

A secondary transfer bias that has the same polarity as the charging polarity of the toner is applied to the secondary-transfer backup roller 53 from a secondary transfer electric power source (not shown). Meanwhile, the secondary transfer roller 56 that is into contact with the front surface of the intermediate transfer belt 51 to form a secondary transfer nip is grounded. Thus, a secondary transfer electric field is formed between the secondary-transfer backup roller 53 and the secondary transfer roller 56. The four-color toner image formed on the front surface of the intermediate transfer belt 51 enters the secondary transfer nip based on the endless movement of the intermediate transfer belt 51.

As shown in FIG. 1, the feeding unit 200 includes a plurality of paper feeding cassettes 201, paper feeding rollers 202, separation rollers 203, and paper conveying roller pairs 205. The paper feeding cassette 201 stores therein recording sheets P. The paper feeding roller 202 feeds recording sheets P stored in the paper feeding cassette 201 outside the cassette. The separation rollers 203 separate the fed recording sheets P one by one. The paper conveying rollers 205 conveys the separated recording sheets P along a feed-out path 204. The feeding unit 200 is arranged beneath the printer unit 1. The feed-out path 204 in the feeding unit 200 is connected to a paper feeding path 70 of the printer unit 1, so that the recording sheets P fed from the paper feeding cassette 201 are conveyed to the paper feeding path 70 via the feed-out path 204.

A pair of registration rollers 71 is arranged as a feed-in unit near a distal end of the paper feeding path 70. A recording sheet P held between the registration rollers 71 is sent into the secondary transfer nip at a timing synchronized with a four-color toner image formed on the intermediate transfer belt 51. At the secondary transfer nip, the four-color toner image formed on the intermediate transfer belt 51 is secondarily transferred collectively to the recording sheet P by the actions of the secondary transfer electric-field and the nip pressure. The secondarily transferred four-color toner image is combined with a while color of the recording sheet P, thereby forming a full-color image. When the recording paper P on which the full-color image is formed is sent from the secondary transfer nip, the recording paper P is detached from the intermediate transfer belt 51.

A conveyor belt unit 75 in which an endless paper-conveying belt 76 is stretched over a plurality of stretching rollers and is endlessly moved counterclockwise is arranged in the left of the secondary transfer nip. The recording sheet P detached from the intermediate transfer belt 51 is passed to a stretched upper surface of the paper-conveying belt 76 and is conveyed to a fixing unit 80.

The recording sheet P conveyed to the fixing unit 80 is inserted into a fixing nip formed between a heating roller 81 and a pressing roller 82. The heating roller 81 includes a heat source such as a halogen lamp (not shown). The pressing roller 82 is pressed toward the heating roller 81. The full-color image is fixed on the recording sheet P, while pressed and heated, which is conveyed outside the fixing unit 80.

A small amount of secondary-transfer remaining toner that is not transferred to the recording sheet P is adhered to the surface of the intermediate transfer belt 51 after the recording sheet P is passed through the secondary transfer nip. The secondary-transfer remaining toner is removed from the belt by a belt cleaning unit 57 coming into contact with the front surface of the intermediate transfer belt 51.

As shown in FIG. 1, a switchback unit 85 is arranged below the fixing unit 80. When a recording sheet P discharged from the fixing unit 80 is conveyed to a conveying-path switching position where a path to convey a recording sheet P is switched by a swingable switching claw 86, the recording sheet P is conveyed to either a pair of discharging rollers 87 or the switchback unit 85 based on a position at which the switching claw 86 stops swinging. When recording sheets P are conveyed to the discharging rollers 87, they are discharged outside an image forming apparatus and are stacked on the discharging tray 3.

On the other hand, when a recording sheet P is conveyed to the switchback unit 85, the recording sheet P is turned upside down through a switchback conveyance performed by the switchback unit 85 and is conveyed to the registration rollers 71 again. Then, the recording sheet P is inserted into the secondary transfer nip again. The full-color image is formed on the other side of the recording sheet P.

When a recording sheet P is manually fed from the manual feed tray 2 provided on a side of the housing of the printer unit 1, the recording sheet P is conveyed to the registration rollers 71 via a manual feeding roller 72 and a pair of manual separation rollers 73.

When an original is copied by the copier according to the embodiment, first, the original is placed on an original glass 401 of the ADF 400. Alternatively, the ADF 400 is opened, the original can be placed on the contact glass 301 of the scanner 300, and then the ADF 400 is closed to hold the original. When a start switch (not shown) is pressed, the original placed on the original glass 401 of the ADF 400 is sent into the contact glass 301. Then, the scanner 300 is driven to scan, i.e., the first scanning unit 303 and the second scanning unit 304 start reading and scanning the original. Almost at the same time, the transfer unit 50 and the process units 1OY, 1OC, 1OM, and 1OK start being driven. Moreover, the recording sheets P start being fed from the feeding unit 200. When a recording sheet P that is not set in the paper feeding cassette 201 is used, a recording sheet P set on the manual feed tray 2 is fed.

FIG. 4 is an enlarged schematic diagram for explaining the secondary transfer nip and its neighborhood. A secondary transfer current flows through the intermediate transfer belt 51 between the secondary-transfer backup roller 53 and the secondary transfer roller 56 that is grounded. A secondary transfer bias that has the same polarity as toner (a negative polarity in FIG. 4) is applied to the secondary-transfer backup roller 53 from a secondary transfer power source 59. The secondary transfer current flows through a path that connects shafts of both of the rollers 53 and 56, that is, a path indicated by a white arrow shown in FIG. 4. Therefore, a secondary transfer of a toner image from the intermediate transfer belt 51 to a recording sheet P is performed at a position (hereinafter, a shaft connecting position) that connects the shafts. When a gap between the front surface of the intermediate transfer belt 51 and the secondary transfer roller 56 is formed slightly on a side of an upstream of the belt away from the shaft connecting position, an electric discharge occurs between the gaps. Thus, toner of a toner image is scattered at a belt area before a recording sheet is inserted into the secondary transfer nip, thereby causing transfer dust.

Therefore, to form a gap at a position relatively away from the shaft connecting position indicated by the white arrow, the intermediate transfer belt 51 is forced to wind around the secondary transfer roller 56 on the upstream side of the belt away from the shaft connecting position in the copier. The intermediate transfer belt 51 is forced to wind around the secondary transfer roller 56 from inside a loop of the intermediate transfer belt 51 by a press-down roller 58 that is arranged on the upstream side of the belt away from the secondary-transfer backup roller 53. The press-down roller 58 presses down the intermediate transfer belt 51 toward the secondary transfer roller 56 from inside the belt loop, so that the intermediate transfer belt 51 is forced to wind around the secondary transfer roller 56. This configuration effectively prevents transfer dust from occurring by keeping a gap far away a position which the secondary transfer current reaches.

The secondary-transfer backup roller 53 includes a cylindrical cored bar 53a made of metal and a conductive elastic layer 53b that is covered around an outer peripheral surface thereof. When a small-size sheet such as an A5-size sheet is used, an area at which the belt in its width direction comes into contact with the small-size sheet relatively becomes small at the secondary transfer nip. When the small-size sheet is inserted into the nip, an area at which the intermediate transfer belt and the secondary transfer roller 56 are brought into direct contact with each other becomes relatively large. In this case, when the secondary transfer current intensively flows to the area of the direct contact between the intermediate transfer belt 51 and the secondary transfer roller 56 to avoid the small-size sheet that has a large electric resistance, an effective transfer electric field that is required at an area of the small-size sheet cannot be obtained, which causes a transfer error. Therefore, an elastic material of the elastic layer 53b to which an ion conductive agent is added after appropriately adjusted is used, and the secondary transfer roller 56 has a volume inherent resistivity equal to or larger than 107 Ω·cm in the copier. Thus, a larger electric resistance than that of a sheet is exerted to the secondary transfer roller 56, so that the secondary transfer current is prevented from intensively being applied to the area of the direct contact.

The secondary transfer roller 56 includes a cylindrical cored bar 56a made of metal, a conductive elastic layer 56b that is covered around an outer peripheral surface thereof, and a surface layer 56c that is made of conductive resin and that is covered around an outer peripheral surface of the elastic layer 56b. A metal material such as stainless or aluminum can be used as the cored bar.

An elastic layer made of a conductive rubber material to which a conductive material or an ion conductive agent is added can be used as the elastic layer 56b. It is desirable that the elastic layer 56b that has a JIS-A hardness equal to or less than 70 degrees is used to make the secondary transfer roller 56 have a larger area to come into close contact with the intermediate transfer belt 51 based on a flexible deformation that the elastic layer 56b has. However, when the elastic layer 56b is too soft, it is hard to perform cleaning due to much softness of the elastic layer 56b because the secondary transfer roller 56 comes into contact with a cleaning blade 60. Thus, it is desirable that the elastic layer 56b has a JIS-A hardness equal to or larger than 40 degrees. The elastic layer 56b made of epichlorohydrin rubber that is adjusted to have a JIS-A hardness of 50 degrees is used in the copier.

A surface layer that is made of ethylene propylene diene monomer (EPDM) rubber in which carbon powder is dissipated to adjust electric resistance or that is made of Si rubber can be used as the surface layer 56c. Alternatively, it is possible to use a surface layer made of nitrile rubber (NBR) or polyurethane rubber that has an ion conductive function. The surface layer 56c has a role of curbing toner adherence to a surface of the secondary transfer roller 56. Therefore, naturally, the surface layer 56c has more excellent toner release properties than the elastic layer 56b.

The intermediate transfer belt 51 and the secondary transfer roller 56 are opposed to each other through a small gap near an approach to the secondary transfer nip. Recently, along with downsizing of an apparatus, a secondary transfer roller that has a smaller diameter is generally used as the secondary transfer roller 56. As shown in FIG. 4, the secondary transfer roller 56 enters the secondary transfer nip at an area of the gap along a path having a relatively large curvature (1/R). On the other hand, the intermediate transfer belt 51 enters the secondary transfer nip along a path having a relatively small curvature. Under this configuration, when a leading edge of a recording sheet P sent to the approach to the secondary transfer nip is hit to the secondary transfer roller 56 with the large curvature, the recording sheet P is easily turned over or sheet jam easily occurs. However, when the leading edge of the recording sheet P is hit to the intermediate transfer belt 51 with the small curvature, the leading edge of the recording sheet P can enter the secondary transfer nip with ease, followed by the movement of the belt surface. Therefore, a guide plate 65 serving as a guide member is arranged on the upstream side of the secondary transfer nip in a direction in which the belt is moved in the copier. A recording sheet P that is conveyed from the registration rollers 71 to the secondary transfer nip touches a tip of the guide plate 65 (an edge of the guide plate 65 on a side of the secondary transfer nip) and is guided to a position of the belt on the upstream side of the secondary transfer nip. Thus, the recording sheet P is reliably hit to the intermediate transfer belt 51 before the sheet P enters the secondary transfer nip. This makes it possible to prevent the sheet P from being turned over or a jam from occurring. Particularly, the copier has a specification in which it is possible to perform high-speed printing, so that it is effective to perform guiding by the guide plate 65.

To enable high-speed printing, higher transfer efficiency at the secondary transfer nip is required in the copier. Therefore, toner is easily adhered to the secondary transfer roller 56. Thus, an electric-field roller 61 is brought into contact with the secondary transfer roller 56 to electrostatically move the toner adhered to the secondary transfer roller 56. The cleaning blade 60 to mechanically scrape toner is also brought into contact with the secondary transfer roller 56. Toner release properties of the secondary transfer roller 56 are enhanced by coating lubricant agents by a lubricant-agent coating unit. The lubricant-agent coating unit includes a coating brush roller 62 and a coil spring 64. The lubricant-agent coating unit is driven to rotate while coming into contact with both of a solid lubricant 63 such as a zinc stearate block and the secondary transfer roller 56. Then, lubricant powder scraped from the solid lubricant 63 is coated to the secondary transfer roller 56 by the coating brush roller 62. The solid lubricant 63 is urged to the coating brush roller 62 by the coil spring 64.

The secondary transfer roller 56 is driven to rotate by a driving system (not shown). This is because, first, the secondary transfer roller 56 cannot be driven to rotate along with a surface movement of the intermediate transfer belt 51 because various members are brought into contact with the secondary transfer roller 56. Secondly, to pass a recording sheet P through the secondary transfer nip at high speeds, it is more effective to rotatably drive the secondary transfer roller 56. As described above, under this configuration, conveyance of a recording sheet P near the approach to the secondary transfer nip is controlled by a rotation driving force of the secondary transfer roller 56 that is brought into pressure contact with a leading edge of the recording sheet P in the secondary transfer nip. The recording sheet P is moved at a similar speed to a line speed of the secondary transfer roller 56 near the approach to the secondary transfer nip.

In view of a limit of processing accuracy in manufacturing, the secondary transfer roller 56 necessarily has a difference of ±0.5% in its outer diameter. Therefore, if a moving speed of the intermediate transfer belt 51 is designed to be the same as the line speed of the secondary transfer roller 56, a small difference in the line speed is necessarily caused. Furthermore, because a center of rotation is slightly decentered with respect to an outer periphery of the secondary transfer roller 56, the line speed of the secondary transfer roller 56 slightly changes per circle. Consequently, it is impossible to ignore a difference of a moving speed between the recording sheet P and the intermediate transfer belt at an area at which the recording sheet P and the belt are in contact with each other near the approach to the secondary transfer nip. The speed difference causes not a few image disorders (hereinafter, transfer deflection) due to friction of a toner image.

The speed at which a recording sheet P is sent by the registration rollers 71 is slightly higher than the speed (=Vp) at which a recording sheet P is conveyed by the secondary transfer roller 56 in the copier. This is because a recording sheet P a leading edge of which is held into the secondary transfer nip and a trailing edge of which is held into a registration nip formed between the registration rollers 71 is prevented from being extended due to too much tension between the secondary transfer nip and the registration nip. Under this speed setting, along with conveyance of the recording sheet P, the recording sheet P is gradually slackened between the secondary transfer nip and the registration nip. Strictly speaking, such slackening is caused between a point at which the recording sheet P is supported by the guide plate 65 and an exit of the registration nip. The recording sheet P is hardly slackened between the point at which the recording sheet P is supported by the guide plate 65 and the approach to the secondary transfer nip. Therefore, the recording sheet P is moved at the line speed (Vp) of the secondary transfer roller 56 near the approach to the secondary transfer nip.

Next, an explanation is given about an experiment performed by the inventor. As shown in FIG. 4, a reference symbol of P1 denotes a point (a nip entrance point) at which the intermediate transfer belt 51 starts entering the nip. A reference symbol of P2 denotes a belt point targeted to guide the recording sheet P by the guide plate 65, that is, a guide target point. A distance L between the guide target point P2 and the nip entrance point P1 means a distance from a recording sheet P1 starting coming into contact with the intermediate transfer belt 51 to starting entering the secondary transfer nip.

An amount by which a toner image is in friction when a recording sheet P and the intermediate transfer belt 51 are moved by the distance L with a small difference in the line speed while they are brought into contact with each other near the approach to the secondary transfer nip is as follows. The amount is obtained by multiplying a difference of the line speed between a moving speed Vp of a recording sheet P (the same as the line speed of the secondary transfer roller 56) and a surface moving speed Vt of the intermediate transfer belt 51 by time taken for the recording sheet P to move for the distance L. This is indicated by an expression of “|L−Vt×L/Vp|”. The longer the distance L, the longer time at which the recording sheet P and the intermediate transfer belt 51 are brought into contact with each other. Therefore, the amount by which a toner image is in friction is increased, so that it is necessary to make the distance L short in a certain extent.

The inventor has performed an experiment by using a copying tester with the configuration shown in FIG. 1. A relation among a distance L, a frequency at which transfer deflection occurs, the expression of “|L−Vt×L/Vp|” is examined by performing a printing test while variously changing the guide target point P2 shown in FIG. 4 based on positional adjustment of the guide plate 65.

A dot-pattern image on which transfer deflection is easily outstanding and a general image having a graphic are printed out as a tested image.

Transfer deflection is determined by checking a printed image with eyes in the following five levels. Rank 5 means that transfer deflection cannot be recognized. Rank 4 means that transfer deflection can be slightly recognized by gazing but is within an allowed range. Rank 3 means that a difference in contrasting density that is caused by image disorder can be recognized. Rank 2 means that a difference in contrasting density can be clearly recognized. Rank 1 means that a difference in contrasting density can be more clearly recognized.

A surface moving speed Vt of the intermediate transfer belt 51 is measured based on the result obtained by detecting a belt mark by the optical sensor unit 69 shown in FIG. 2. Though speed variation is slightly recognized, the variation can be ignored. The measured result is 282.0 millimeters per second as a designed value indicates.

A speed Vp at which a recording sheet P is moved, that is, the line speed of the secondary transfer roller 56 is calculated based on the result obtained by measuring the rotation number and an outer diameter of the secondary transfer roller 56. Specifically, a rotary encoder is attached to a shaft of the secondary transfer roller 56 and the rotation number of the secondary transfer roller 56 is measured by the rotary encoder. The outer diameter of the secondary transfer roller 56 changes in response to temperature. Therefore, before measuring the rotation number, the outer diameter of the secondary transfer roller 56 is previously measured under a predetermined temperature environment. The moving speed Vp is obtained based on the measured result of the rotation number and the outer diameter. The measurement is performed in the experiment under the temperature environment of 25 degrees centigrade that is a temperature generally-set in an office.

The results of the experiment based on the above conditions are indicated in a graph shown in FIG. 5. As shown in FIG. 5, when a distance L is equal to or smaller than 13 millimeters, it is possible to reduce transfer deflection to such an extent that it cannot be recognized with eyes in a dot-pattern image or a general image (rank 5). When Vp, Vt, and the distance L of 13 millimeters in the experiment are substituted in the expression of “|L−Vt×L/Vp|”, an amount by which a toner image is in friction is 64 micrometers. It is said that a human cannot recognize a dot in resolutions equal to or more than 400 dpi with eyes. A diameter of dot in 400 dpi is about 65 micrometers, which is almost the same as 64 micrometers that is the amount by which a toner image is in friction when a distance L is 13 millimeters. Therefore, the solution obtained by the expression of “|L−Vt×L/Vp|” is kept less than 65 micrometers, so that it is possible to reduce transfer deflection to a level (rank 5) in which a human cannot recognize with eyes.

The guide plate 65 is arranged at a position to satisfy a relation of “65 micrometers>|L−Vt×L/Vp|” in the copier according to the embodiment. Generally, a user hardly outputs a dot pattern. Therefore, it is sufficient if transfer deflection is kept in rank 4 in an actual copier in outputting a general image. As shown in FIG. 5, to satisfy the condition, a distance L is 20 millimeters. When the distance of 20 millimeters is substituted in the expression of “|L−Vt×L/Vp|”, an amount by which a toner image is in friction is 99 micrometers. Consequently, it is possible to reduce transfer deflection to an inconspicuous level by keeping the solution of the expression less than 100 micrometers.

As described above, it is possible to reduce transfer deflection on the whole area of an image to a level in which a human cannot recognize with eyes by keeping an amount by which a toner image is in friction less than 65 micrometers. However, relatively outstanding transfer deflection occurs at a trailing edge of the recording sheet alone as an exception. This is because, when the trailing edge of the recording sheet P is away from the guide plate 65, the trailing edge of the recording sheet P is forced to hit the belt based on a restoring force generated from a slackening state due to stiffness of the recording sheet P.

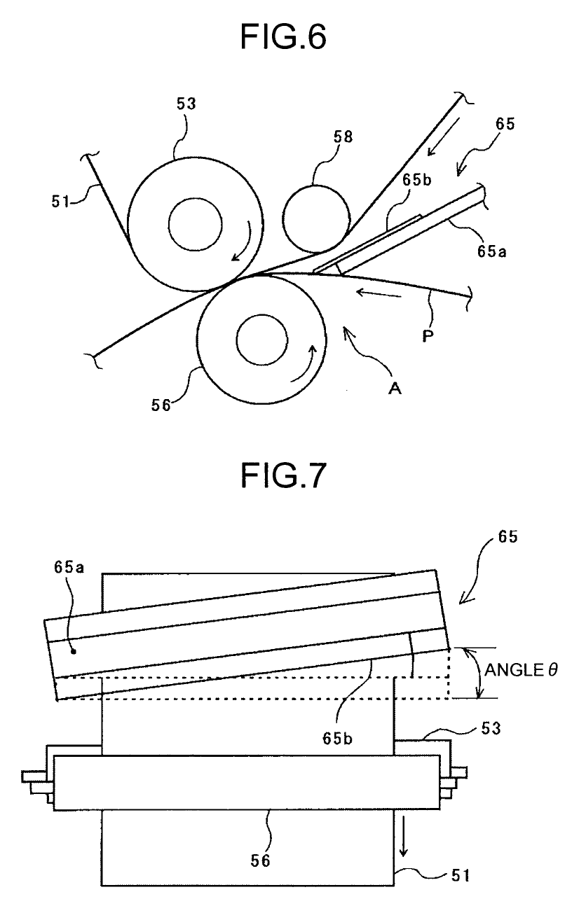

Therefore, the guide plate 65 that has a configuration shown in FIG. 6 is employed in the copier according to the embodiment. As shown in FIG. 6, the guide plate 65 includes a first guiding unit 65a that guides a leading edge of the recording sheet P with which the guide plate 65 comes into contact to the guide target point of the intermediate transfer belt 51 and a second guiding unit 65b that is made of a flexible member and that guides the recording sheet P to the guide target point while the second guiding unit 65b is supported by a tip of the first guiding unit 65a in a cantilever manner.

When the guide plate 65 is slackened due to a contact with the recording sheet P, the recording sheet P is hit to the intermediate transfer belt 51 on an upstream side of the belt moving direction away from the guide target point, so that transfer deflection may be increased. Thus, it is desirable to use the guide plate 65 that is not easily slackened. The first guiding unit 65a is made of a metal plate that has high stiffness. Therefore, even if a thick sheet is hit to the first guiding unit 65a, the first guiding unit 65a is not slackened. This makes it possible to prevent transfer deflection caused by the slackened guide plate 65 from being increased.

As soon as a trailing edge of the recording sheet P is detached from the first guiding unit 65a while conveyed, the trailing edge thereof may be urged to hit to the intermediate transfer belt 51. Therefore, the guide plate 65 includes the second guiding unit 65b made of a flexible member to guide the recording sheet P to the guide target point while the second guiding unit 65b is supported by the tip of the first guiding unit 65a in a cantilever manner. When the second guiding unit 65b comes into contact with the trailing edge of the recording sheet P that is away from the first guiding unit 65a, the second guiding unit 65b is bent toward the intermediate transfer belt 51 based on its good flexibility. Thus, the trailing edge thereof is detached from the intermediate transfer belt 51 just near the intermediate transfer belt 51. For this reason, a force by which the trailing edge of the recording sheet P is hit to the belt due to stiffness of the recording sheet P is significantly reduced, so that transfer deflection that occurs to the trailing edge thereof (hereinafter, a trailing-edge transfer deflection) alone can be reduced. A polyethylene terephthalate (PET) sheet that has a thickness of 0.1 millimeter is used as the second guiding unit 65b.

As shown in FIG. 6, the first guiding unit 65a includes a surface that comes into contact with the recording sheet P and an opposite surface that faces the belt. The second guiding unit 65b is supported by the opposite surface in a cantilever manner. However, when the second guiding unit 65b is supported by the surface that comes into contact with the recording sheet P, the second guiding unit 65b is kept away from the belt, whereby easily causing the trailing-edge transfer deflection. Therefore, the second guiding unit 65b is supported by the opposite surface in a cantilever manner. Under this configuration, compared with a case in which the second guiding unit 65b is supported by the surface that comes into contact with the recording sheet P in a cantilever manner, the trailing edge of the recording sheet P is detached from the intermediate transfer belt 51 at a position that is closer to the belt, so that it is possible to prevent the trailing-edge transfer deflection.

A recording sheet P that has stiffness such as a thick sheet may cause a trailing-edge transfer deflection that can be recognized with eyes. Therefore, the inventor performs the following experiment. As shown in FIG. 7, a tip of the second guiding unit 65b is inclined to have an angle of θ with respect to a sheet-width direction that is perpendicular to a surface of the recording sheet in its conveying direction. Under this state, a timing at which part of a trailing edge of the recording sheet P in its width direction is detached from the second guiding unit 65b and a timing at which the other part of the trailing edge of the recording sheet P in the width direction is detached from the second guiding unit 65b are shifted. Then, compared with a case in which both of the parts are detached at the same time, a restoring force based on stiffness at the trailing edge of the recording sheet is reduced, so that the trailing-edge transfer deflection can be reduced.

The inventor performs an experiment to examine about how large an angle of θ should be. Two types of recording sheets are used such as a thick sheet that has stiffness and that may easily cause a trailing-edge transfer deflection and an art sheet that is thick and lusterless. The result is indicated in the following table 1.

TABLE 1

| | |
|---|---|
| | rank of trailing-edge |
| angle θ [degrees] | deflection |

| first guiding | second guiding | lusterless | |
|---|---|---|---|
| unit | unit | art sheet | thick sheet |
| 0 | 0 | 1 | — |
| 0.1 | 0.1 | 1.5 | 2 |
| 0.2 | 0.2 | 4.5 | 5 |
| 0.4 | 0.4 | 5 | 5 |
| −0.2 | −0.2 | 4.5 | 5 |
| −0.4 | −0.4 | 5 | 5 |

As shown in Table 1, when the angle of θ is equal to or larger than 0.2 degree, the trailing-edge transfer deflection can be kept in rank 4 or higher that is within an allowed range. Therefore, the angle of θ is set to be equal to or larger than 0.2 degree in the copier according to the embodiment. When a recording sheet P is conveyed, skew may be slightly caused. If skew is caused, it is desirable that the angle of θ is equal to or larger than 0.4 degree, to have a room to spare, in such a manner to keep the trailing-edge transfer deflection within the allowed range. A more desirable value of the angle of θ can be cited. It is a value obtained in such a manner that, after part of a trailing edge of a recording sheet in its width direction is detached from the second guiding unit 65b, the part is brought into contact with the intermediate transfer belt 51, and the other part is detached from the second guiding unit 65b. It is appropriate at least that, after part of a trailing edge of a maximum size of recording sheet P in its width direction that can be accommodated in the paper feeding cassette 201 is brought into contact with the intermediate transfer belt 51, the other part thereof can be detached from the second guiding unit 65b.

The explanation is given about the case in which the whole guide plate 65 is inclined. However, only the first guiding unit 65a can be inclined without inclining the second guiding unit 65b.

So far, the copier in which the intermediate transfer belt 51 is used as an image carrier belt is explained. The present invention can be also applied to an image forming apparatus in which another image carrier belt is used such as a photosensitive belt. Furthermore, the present invention can be applied, but not limited to a tandem image forming apparatus, to a black-and-white image forming apparatus.

According to an aspect of the present invention, an amount by which a toner image is in friction near an entrance to a transfer nip is less than 100 micrometers. Specifically, “a distance L/a speed Vp at which a recording sheet is moved” in the expression of “100 micrometers>|L−Vt×L/Vp|” represents time to take during which, after a recording sheet guided by a guiding member is brought into contact with an image carrier belt, the recording sheet enters a transfer nip (hereinafter, a recording-sheet moving time). The recording-sheet moving time is multiplied by a speed Vt at which the image carrier belt is moved is a distance (Vt×L/Vp) for which the image carrier belt is moved in the recording-sheet moving time (hereinafter, a belt-moving distance). An absolute value of a value obtained by subtracting the belt-moving distance from a distance L from a point at which a recording sheet starts entering the transfer nip to the guide target point is a difference between the belt-moving distance and a recording-sheet moving distance generated in the recording-sheet moving time, that is, an amount by which a toner image is in friction. The inventor finds based on the experiment that, if the amount by which a toner image is in friction between the image carrier belt and the recording sheet near an entrance to the transfer nip is kept less than 100 micrometers, it is possible to reduce image disorder to an inconspicuous level.

Furthermore, according to another aspect of the present invention, the transfer nip is extended to an upstream side in a direction in which the image carrier belt is moved by partially winding the image carrier belt around a contact member, so that the entrance to the transfer nip is positioned farther from a transfer electric field. Thus, an electric discharge is prevented from occurring at a gap near the entrance to the transfer nip, so that it is possible to prevent transfer dust from occurring due to the electric discharge. A trailing edge of the recording sheet that is detached from a first guiding unit of a guiding member while conveyed is held by a second guiding unit and the second guiding unit guides the trailing edge of the recording sheet toward the image carrier belt while flexibly bent. The trailing edge of the recording sheet is passed to the image carrier belt while in closer contact with the image carrier belt. Therefore, image disorder on the trailing edge of the recording sheet that is caused by urging the trailing edge of the recording sheet that is detached from the guiding member to bring into contact with the image carrier belt is prevented. Furthermore, a timing at which the trailing edge of the recording sheet is detached from the second guiding unit is made different in one part and the other part in a direction perpendicular to a direction in which the recording sheet is conveyed. Thus, compared with a case in which both of the parts are detached at the same time, a force caused when the trailing edge of the recording sheet is urged to bring into contact with the image carrier belt is reduced. This makes it possible to moreover prevent image disorder on the trailing edge of the recording sheet from occurring.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
an image carrier belt that is endlessly moved, on which a toner image is formed;
a contact member that makes contact with a surface of the image carrier belt to form a transfer nip with the image carrier belt;
a feeding unit that feeds a recording medium to the transfer nip;
a guiding member that guides the recording medium fed by the feeding unit to a guide target point on an upstream side of an entering point at which the recording medium starts entering the transfer nip on the surface of the image carrier belt in a moving direction of the image carrier belt, the guiding member being arranged at a position satisfying
100 [μm]>|L−Vt×L/Vp|

where L is distance from the entering point to the guide target point on the image carrier belt, Vp is moving speed of the recording medium, and Vt is surface moving speed of the image carrier belt;
a pressing unit that presses the image carrier belt from inside a loop such that the image carrier belt is partially wound around the contact member to extend the transfer nip to the upstream side of the surface moving direction of the image carrier belt, wherein
the guiding member includes
a first guiding unit that guides the recording medium that comes into contact with a tip of the first guiding unit to the guide target point, and
a second guiding unit that is made of a flexible member that guides the recording medium to the guide target point while being supported by the tip of the first guiding unit in a cantilever manner, and that is constituted to make a detach timing at which a trailing edge of the recording sheet fed to the transfer nip is detached from the second guiding unit different at a first edge part and a second edge part in a direction perpendicular to a conveying direction of the trailing edge.

2. The image forming apparatus according to claim 1, wherein
the first guiding unit includes
a first surface that makes contact with the recording medium, and
a second surface that faces the first surface, and
the second guiding unit is supported by the second surface in a cantilever manner.

3. The image forming apparatus according to claim 1, wherein a tip of the second guiding unit is inclined to make an angle with respect to a direction perpendicular to a moving direction of the recording medium, so that the detach timing is made different at the first edge part and the second edge part.

4. The image forming apparatus according to claim 3, wherein the angle is equal to or larger than 0.2 degree.

5. The image forming apparatus according to claim 4, wherein the angle is equal to or larger than 0.4 degree.

6. The image forming apparatus according to claim 1, wherein, after the first edge part is detached from the second guiding unit and is brought into contact with the image carrier belt, the tip of the second guiding unit is inclined with respect to the direction perpendicular to the moving direction of the recording medium with an angle at which the second edge part is detached from the second guiding unit.

7. The image forming apparatus according to claim 1, wherein the position satisfies
65 [μm]>|L−Vt×L/Vp|.

8. An image forming apparatus comprising:
an image carrier belt that is endlessly moved, on which a toner image is formed;
a contact member that makes contact with a surface of the image carrier belt to form a transfer nip with the image carrier belt;
a feeding unit that feeds a recording medium to the transfer nip; and
a guiding member that guides the recording medium fed by the feeding unit to a guide target point on an upstream side of an entering point at which the recording medium starts entering the transfer nip on the surface of the image carrier belt in a moving direction of the image carrier belt, wherein
the guiding member is arranged at a position satisfying
100 [μm]>|L−Vt×L/Vp|

where L is distance from the entering point to the guide target point on the image carrier belt, Vp is moving speed of the recording medium, and Vt is surface moving speed of the image carrier belt

9. The image forming apparatus according to claim 8, wherein the guiding member includes
a first guiding unit that guides the recording medium that comes into contact with a tip of the first guiding unit to the guide target point, and
a second guiding unit that is made of a flexible member that guides the recording medium to the guide target point while being supported by the tip of the first guiding unit in a cantilever manner, and
a tip of the first guiding unit is inclined to make an angle with respect to a direction perpendicular to a moving direction of the recording medium, so that the detach timing is made different at a first edge part and a second edge part in a direction perpendicular to a conveying direction of the trailing edge.

10. The image forming apparatus according to claim 8, wherein the position satisfies
65 [μm]>|L−Vt×L/Vp|.
